(19) United States
(12) Patent Application Publication
(10) Pub. No.: US 2009/0129473 A1
(43) Pub. Date: May 21, 2009

(54) SYSTEM AND METHOD FOR ADJUSTING COMPRESSION NOISE REDUCTION BASED ON GLOBAL AND LOCAL MOTION DETECTION

(75) Inventors: Sangkeun Lee, Irvine, CA (US); Yeong-Taeg Kim, Irvine, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon (KR)

(21) Appl. No.: 11/942,587

(22) Filed: Nov. 19, 2007

(51) Int. Cl. H04N 7/26

(52) U.S. Cl. 375/240.16; 375/E07.124

(57) ABSTRACT

A method of processing image data, comprising receiving image data, the image data discretizable into a plurality of segments and a plurality of motion vectors, each motion vector having a length and being associated with one of the plurality of segments, analyzing the motion vector of one of the plurality of segments of the image data, wherein the length of the motion vector is compared to a predetermined value, and adjusting the one segment by adjusting the degree of noise reduction applied to the image data comprising the segment.

### BACKGROUND

1. Field

The development relates to video compression and more particularly, to noise reduction in compressed video.

2. Discussion of Related Technologies

Digital video images are frequently compressed to conserve storage space. Compression algorithms can be effective at reducing the space needed to store video images, but typically at the cost of video quality. Video imperfections due to compression are frequently manifested as blocky, blurry portions of the video and are called artifacts. While increased compression is useful for storage purposes, maintaining video quality is desirable to maintain a minimum level of visual clarity and may be a higher priority when storage space is abundant.

### SUMMARY

One aspect of the development includes a method of processing image data, comprising receiving image data, the image data comprising a plurality of discrete segments and a plurality of motion vectors, each motion vector having a length and being associated with one of the plurality of segments; analyzing the motion vector of one of the plurality of segments of the image data, wherein the length of the motion vector is compared to a predetermined value; and adjusting the degree of noise reduction of the image data comprising the segment based on the length of the motion vector.

### BRIEF DESCRIPTION OF THE DRAWINGS

FIG. 1 is a block diagram which illustrates a system for adjusting video compression techniques to reduce noise.

FIGS. 2A-2D are graphical representations illustrating change in image composition in pixel blocks with and without noise reduction.

### DETAILED DESCRIPTION OF THE EMBODIMENTS

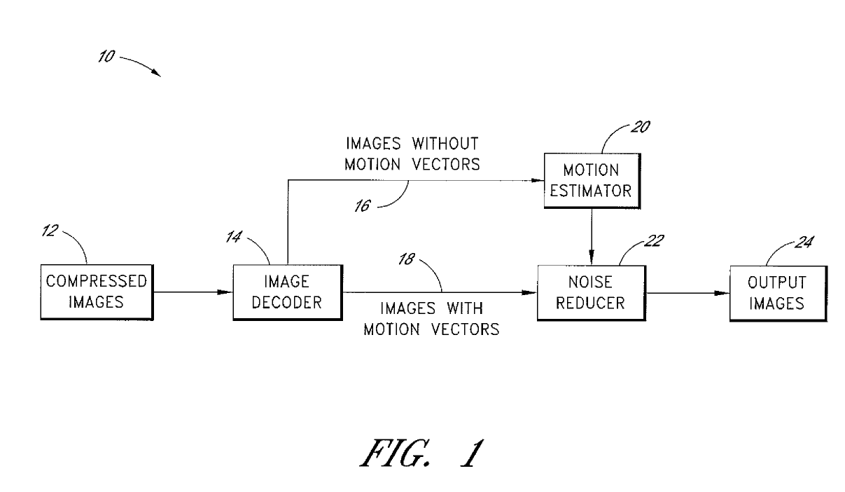

FIG. 1 illustrates a system 10 for modifying video images to reduce or eliminate video imperfections known as blocking caused by compression techniques. Blocking can result from increased compression, wherein some detail of the image is sacrificed to reduce the file size. The coarser resolution in the block results in a loss of detail. One form of compression is to simplify image information by altering the value of some pixels or pixel blocks to be equal to neighboring pixels or pixel blocks, reducing variations in value, and correspondingly reducing the quantity of data stored to represent the pixels or blocks. This compression technique results in a loss of image information, and a loss of detail in the image.

Video images can be discretized into pixel blocks for application of compression techniques. A pixel block can be a single pixel, or a larger number of pixels grouped together and treated as a unit. As an example, a group of nine pixels disposed in a square can be a pixel block. Similarly, a group of one hundred pixels disposed in a square with ten pixels on each edge can be a pixel block. Pixel blocks can have regular or irregular geometric shapes, as well.

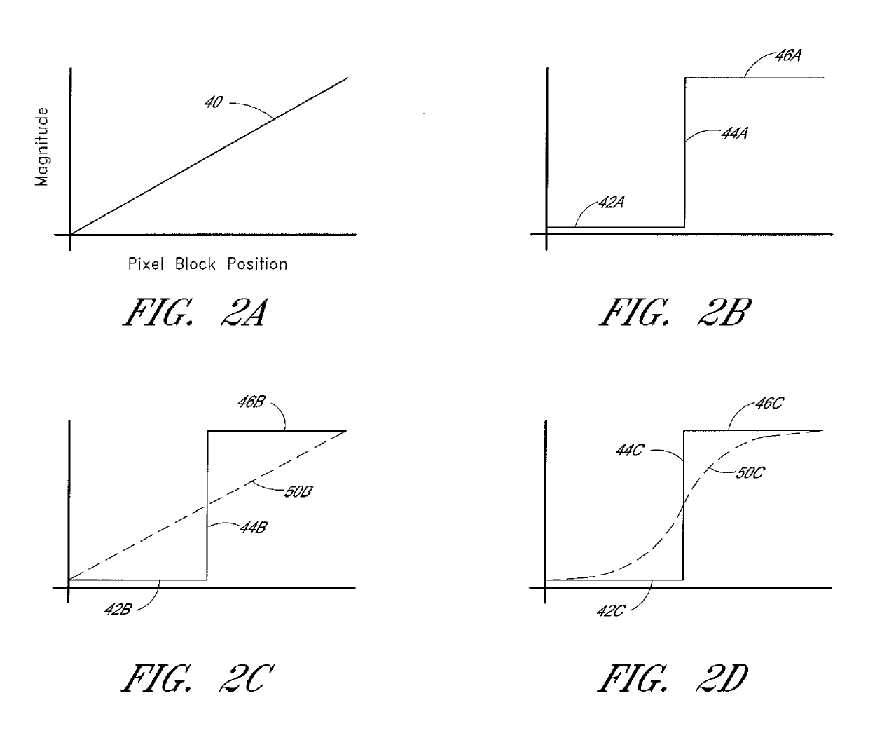

With additional reference to FIGS. 2A-2D, the value of a variable parameter 40 associated with pixels within a pixel block in uncompressed video images is displayed. The parameter may be, among other things, the brightness of the pixel, the hue of the pixel, or the value of a single color component (e.g., red, green, or blue) of the pixel. The variable parameter 40 can be one used by a compression algorithm to compress the video images. In one embodiment, as shown in FIG. 2A, the value of the parameter 40 may increase linearly across the pixel block, beginning at a low point near one side of the block, and ending at a higher point on the other side of the block. FIG. 2B illustrates the same variable parameter 42A, 44A, 46A across the pixel block after compression processing. In some embodiments, as shown, portions of the pixel block can experience a reduced value 42A which can climb sharply along an intermediate portion 44A of the block to a higher value 46A. Thus, a value distribution resembling a step function can be created by the processing, possibly resulting in a sharp change in value over small portions of the pixel block. Similarly, the resolution and corresponding detail of the image present in FIG. 2A, wherein intermediate values are present, is removed for a much coarser resolution of value across the pixel block.

The sharp change in value at the location 44A can cause neighboring portions of the pixel block to have sufficiently different values such that the overall quality of the pixel block is degraded. Additionally, when the pixel block is large, or groups of adjacent smaller pixel blocks manifest this characteristic, distorted image data can impair enjoyable viewing of the video. Such visual imperfections can be referred to as blocking, artifacts, or MPEG noises.

Typically, the compression algorithm used to create the compressed video images 12 from uncompressed video images can be applied to varying degrees, wherein greater compression can be performed at the expense of quality. Similarly, lesser compression can be performed with a correspondingly greater quality. One such algorithm is the Motion Picture Expert Group (MPEG) compression method, though other compression algorithms, including without limitation, Divx, Xvid, Quicktime, MPEG-2, MPEG-4, Windows Media Video (WMV), RealVideo, and AVI, can also be used. Upon decompression, visual imperfections such as blocking, artifact, or MPEG noises may be present. A noise reduction algorithm may be performed upon the decompressed images to attempt to mitigate these effects. It may be advantageous to identify pixel blocks or groups of pixel blocks most likely to suffer from these visual imperfections and adjust the degree to which they are processed by the noise reduction algorithm.

Accordingly, a method of detecting visual imperfections to identify pixel blocks or groups of pixel blocks to be processed can be used. One such method can include evaluation of motion vectors of pixel blocks. Motion vectors can be evaluated to determine regions of imperfections or noise. Motion vectors are mathematical computations of the movement of a pixel block between successive frames. Thus, for a pixel block with a known location in a first frame, the location of the pixel block in a second, subsequent frame can be determined using the motion vector for the pixel block.

Large, or long, motion vectors can indicate large movement between successive frames for a given pixel block. Such large movement can in turn indicate a moving object. Because blocking is more easily detectable by the human eye near dynamic objects in a video, use of motion vectors can provide a method of determining pixel blocks or groups of pixel blocks likely to display noise. Although compressed images 12 are illustrated using the process in FIG. 1, video images can be evaluated either before or after compression to determine likelihood of noise. Where uncompressed video images are used, an image decoder 14 may be omitted from the system 10.

The system 10 of FIG. 1 takes compressed video images 12 as input. After compressed images 12 are decoded by the image decoder 14, whereby uncompressed video images are produced, the result can be images with motion vector information 18, or images without motion vector information 16. For those instances where images without motion vector information 16 are output by the decoder 14, the decoded images 16 can be received by a motion estimator 20, which produce motion vectors for the decoded images 16.

Thus, whether through the motion estimator 20 or through decoding by the decoder 14, images with motion vector information are provided to the noise reducer 22. The noise reducer 22 evaluates the motion vectors between successive frames of video to determine if noise or blocking is likely to occur in pixel blocks of the video images. If it is determined that the motion vector information indicates that blocking is unlikely to occur, the noise reducer 22 can leave the pixel block unaltered. If the motion vector analysis indicates that blocking is likely in a pixel block, the noise reducer 22 can increase the degree of noise reduction of the noise reduction algorithm used in the pixel block to improve the quality of the video and correspondingly reduce the noise in the pixel block.

In one embodiment, a value of three for a motion vector length, indicating a length of three pixel blocks, or less can be used as a lower threshold for slow-moving or stationary pixel blocks unlikely to cause blocking. Thus, pixel blocks having a motion vector length below the lower threshold may not be subjected to noise reduction. In some cases, a threshold as low as zero can be used, indicating that pixel blocks having a motion vector with a length greater than zero can have some degree of noise reduction applied, while stationary pixel blocks have no noise reduction.

An upper threshold value of length ten, for example, can also be used, indicating that for pixel blocks having a motion vector length of ten between successive frames, movement of the pixel block is large enough that noise reduction should be maximally applied to prevent blocking. The upper threshold can be set to any value larger than the lower threshold.

Once evaluated, for those pixel blocks having a motion vector length below the lower threshold, noise reduction is not applied, and output images 24 are produced. For those pixel blocks having a motion vector length above the upper threshold, the degree of noise reduction is set to a maximum amount for maximum reduction of blocking, and other visual imperfections.

For those pixel blocks having a motion vector length value between the lower and upper thresholds, the degree of noise reduction may be scaled. In one embodiment, the degree to which the noise reduction algorithm is applied can be adjusted by the formula:

Y(p)=[1−ƒ(rel(l)]*X(p)+ƒrel(l))*Xₙᵣ(p)

where (p) indicates a pixel block, Y is the output of combining between compressed input X and noise-reduced output Xₙᵣ, rel(l) is the relative length of the motion vector of the pixel block compared to the upper and lower threshold values, and ƒ(rel(l)) is a function of the relative length. To determine ƒ(rel(l), the motion vector length, l, is compared against threshold values. There are preferably two threshold values, though more can be used with finer-resolution functions. In one embodiment, threshold values of τ₁ and τ₂ can be used. A value for the lower value, τ₁ can be a motion vector length of 3, though higher and lower values can be used, including zero. A motion vector length of 10 can be used for τ₂, though higher and lower values can be used, though preferably above 4 and lower than 100. For motion vector lengths falling between τ₁ and τ₂, a scaling function can be used. One such function can be:

rel(l)=(τ₂−l)/(τ₂−τ₁)

where l is the length of the motion vector of pixel block p. The function results in a reduced value of ƒ(l) as the value of l increases.

Thus, the degree of noise reduction can be linearly adjusted based on the motion vector length of a particular pixel block. With reference to FIG. 2C, the lower value 42B is shown as having a large shift to the higher value 46B at the location 44B. After processing, the gradient between low 42B and high 46B values can be smoother, resulting in a transition 50B between values which does not creating blocking.

Although a linear transition is illustrated, as shown in FIG. 2D, a non-linear transition 50C between low 42C and high 46C values can also be used. In such a transition, an exponential equation can be applied having the same principles as those disclosed herein. As another non-limiting example, a logarithmic equation could also be used.

In another embodiment, one threshold value can be used, and the degree of noise reduction can be proportional to the difference between the motion vector length and the threshold value.

Similarly, in some embodiments, many threshold values can be used to adjust the gain over a correspondingly fine range.

In some embodiments, a computer can be employed to perform the calculations necessary to implement the image enhancement and adjustment thereof. In some embodiments, the processing can be performed by components of an integrated circuit.

The foregoing description sets forth various preferred embodiments and other exemplary but non-limiting embodiments of the inventions disclosed herein. The description gives some details regarding combinations and modes of the disclosed inventions. Other variations, combinations, modifications, modes, and/or applications of the disclosed features and aspects of the embodiments are also within the scope of this disclosure, including those that become apparent to those of skill in the art upon reading this specification. Thus, the scope of the inventions claimed herein should be determined only by a fair reading of the claims that follow.

What is claimed is:

1. A method of processing image data, comprising:
receiving image data, the image data discretizable into a plurality of segments and a plurality of motion vectors, each motion vector having a length and being associated with one of the plurality of segments;
analyzing the motion vector of one of the plurality of segments of the image data, wherein the length of the motion vector is compared to a predetermined value; and
adjusting the one segment by adjusting the degree of noise reduction applied to the image data comprising the segment.

2. The method of claim 1, wherein the image data is compressed.

3. The method of claim 1, wherein the image data is uncompressed.

4. The method of claim 3, wherein adjusting the segment results in uncompressed image data.

5. The method of claim 3, wherein adjusting the segment results in no change to the image data comprising the segment.

6. The method of claim 1, wherein the steps of analyzing and adjusting are performed for each segment of the image data.

7. The method of claim 1, wherein the one segment comprises a single pixel.

8. The method of claim 1, wherein the one segment comprises a quadrangular-shaped group of pixels.

9. A system for reducing visual distortion in compressed video images, the system comprising:
a motion estimator configured to receive video image data having a plurality of discrete segments, each segment having an associated motion vector and each motion vector having a length; and
a noise reducer configured to receive a plurality of discrete segments of video image data, each of the discrete segments having an associated motion vector, the noise reducer adapted to remove visual imperfections of the video image data at a plurality of degrees.

10. The system of claim 9, further comprising an image decoder configured to receive video image data.

11. The system of claim 10, wherein the image decoder is adapted to discretize the received video image data into image segments.

12. The system of claim 10, wherein the image decoder is adapted to provide the discretized video image data to the motion estimator.

13. The system of claim 11, wherein the received video image data comprises vector information.

14. The system of claim 12, wherein the image decoder is adapted to associate a motion vector with the discrete image segments.

15. The system of claim 9, wherein the noise reducer is adapted to adjust the level of noise reduction of an image segment.

16. The system of claim 15, wherein the video image data received by the motion estimator is compressed.

17. The system of claim 15, wherein the video image data received by the motion estimator is uncompressed.

18. The system of claim 17, wherein the noise reducer is adapted to remove visual imperfections in the video image data.

19. A system for reducing visual distortion in compressed video images, the system comprising:
means for receiving image data, the image data discretizable into a plurality of segments and a plurality of motion vectors, each motion vector having a length and being associated with one of the plurality of segments;
means for analyzing the motion vector of one of the plurality of segments of the image data, wherein the length of the motion vector is compared to a predetermined value; and
means for adjusting the one segment by adjusting the degree of noise reduction applied to the image data comprising the segment.
